(19) United States
(12) Patent Application Publication
(10) Pub. No.: US 2025/0352416 A1
(43) Pub. Date: Nov. 20, 2025

(54) PATIENT TABLE

(71) Applicant: CL Safety Support, LLC, Powell, OH (US)

(72) Inventor: James Cachat, Powell, OH (US)

(73) Assignee: CL Safety Support, LLC, Powell, OH (US)

(21) Appl. No.: 19/208,157

(22) Filed: May 14, 2025

Related U.S. Application Data
(60) Provisional application No. 63/647,327, filed on May 14, 2024.

(51) Int. Cl. A61G 7/10; A61G 7/012; A61G 7/08

(52) U.S. Cl. CPC A61G 7/1074; A61G 7/012; A61G 7/08

(57) ABSTRACT

A patient table for adult patients includes an upper structure, a lower structure, and a hydraulic lifting system. The upper structure is configured support the adult patient and includes upper sections that are pivotably coupled to each other to change the between expanded and collapsed configurations. The lower structure is configured to support the upper structure above a ground surface and includes leg systems that are each extendable to change between extended and unextended configurations and that are each pivotably coupled to one of the upper sections to change between an in-use configuration extending downward from the upper section to which it is coupled and a stowed configuration contained within the upper section to which it is coupled. The lifting system is configured to change the leg systems from the unextended configuration to the extended configuration to lift the upper structure and from a lowered position to an elevated position.

### CROSS-REFERENCE TO RELATED APPLICATION(S)

This application claims priority to and the benefit of U.S. Provisional Application No. 63/647,327, filed May 14, 2024, the entire disclosure of which is incorporated by reference herein.

### TECHNICAL FIELD

The present disclosure relates to patient care and, in particular, tables for providing medical care.

### BACKGROUND

Adult patients require caregivers change dressings or clean adult patients in various different settings. It would be advantageous to provide a patient table that is configured to support and lift adult patients, while also being easily portable.

### SUMMARY

A patient table for adult patients includes an upper structure, a lower structure, and a lifting system. The upper structure is configured support the adult patient and includes upper sections that are pivotably coupled to each other to change the between expanded and collapsed configurations. The lower structure is configured to support the upper structure above a ground surface and includes leg systems that are each extendable to change between extended and unextended configurations and that are each pivotably coupled to one of the upper sections to change between an in-use configuration extending downward from the upper section to which it is coupled and a stowed configuration contained within the upper section to which it is coupled. The lifting system is configured to change the leg systems from the unextended configuration to the extended configuration to lift the upper structure and from a lowered position to an elevated position.

The lifting system may be hydraulic. The lifting system may change the leg systems from the unextended configuration to the extended configuration in unison. The lifting system may include a hydraulic pump, hydraulic cylinders, and hydraulic lines that cooperatively form hydraulic circuits, each of the hydraulic circuits being associated with one leg of the leg systems.

Each of the leg systems may include two of the legs that each includes three leg sections that are telescoping. The hydraulic system may include two of the hydraulic cylinders associated with each of the legs that cause the leg sections to telescopically extend from each other.

The hydraulic pump may be configured to pump the hydraulic fluid in the fluid circuits at the same rate. The hydraulic pump may be manually operated.

The upper structure may include a first upper section, a second upper section pivotably coupled to the first upper section, a third upper section pivotably coupled to the third upper section, and a fourth upper section pivotably coupled to the third upper section. When changing from the expanded configuration to the collapsed configuration, upper surfaces of the first upper section and the upper section pivot upward toward each other, bottom surfaces of the second upper section and the third upper section pivot downward toward each other, and upper surfaces of the third upper section and the fourth upper section pivot upward toward each other.

Each of the upper sections may include a frame that defines a lower surface of the upper section and a platform coupled to the frame that forms an upper surface of the upper section. In the expanded configuration, the lower surfaces of the upper sections may be parallel and coplanar. In the collapsed configuration, the lower surfaces of the first upper section and the second upper section may be parallel and face away from each other, the lower surfaces of the second upper section and the third upper section may be parallel and face toward each other, and the lower surfaces of the third upper section and the fourth upper section may be parallel and face away from each other. The first upper section and the second upper section may be configured to pivot about an axis that is above the frames thereof, and the third upper section and the fourth upper section may be configured to pivot about another axis that is above the frames thereof.

The patient table may include one or more guards, each one of the guards being coupled to one of the upper sections to both extend upward from the upper section and be stored within a cavity of the upper section. Each one of the guards may be pivotably coupled to the upper section to move between positions extending upward from the upper section and being stored within the cavity of the upper section.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a top view of an embodiment of a patient table in an expanded configuration.

FIG. 1B is a side view of the patient table of FIG. 1A in an expanded and raised configuration with legs systems unfolded and extended.

FIG. 1C is a front view of the patient table of FIG. 1A in the expanded and raised configuration of FIG. 1B.

FIG. 1D is a front view of the patient table of FIG. 1A in an expanded and lowered configuration with the leg systems unextended (hidden portions of components of the leg systems depicted in dashed lines).

FIG. 1E is a side view of the patient table of FIG. 1A in a partially expanded configuration with the leg systems folded and unextended (hidden and depicted in dashed lines).

FIG. 1F is a side view of the patient table of FIG. 1A in a fully-collapsed configuration.

FIG. 2A is a perspective view of an embodiment of the patient table of FIG. 1A in the expanded and raised configuration.

FIG. 2B is a perspective view of the patient table of FIG. 2A in the fully-collapsed configuration.

FIG. 2C is another perspective view of the patient table of FIG. 2A in the expanded and raised configuration without support surfaces.

FIG. 2D is a partial perspective view illustrating a securing mechanism of the patient table of FIG. 1A.

FIG. 2E is a perspective view of the patient table of FIG. 2A with in the collapsed configuration with a cover.

FIG. 3A is a side view of an upper section of the patient table with a guard in an upright and extended position (solid lines) and non-extended configuration (dashed lines).

FIG. 3B is a front view of the upper section of the patient table and the guard of FIG. 3A in the upright position (solid lines) and a stowed position (dashed lines).

FIG. 3C is a partial top view of two of the upper sections of the patient table and another embodiment of the guard in an extended configuration (solid lines) and a collapsed configuration (dashed lines).

FIG. 3D is a front view of the upper section of the patient table and the guard moving from the stowed position (dashed lines) through an intermediate position (dashed lines) and the in-use position (solid lines).

FIG. 4A is a schematic view of a hydraulic lifting mechanism.

FIG. 4B is a schematic front view of a leg of the patient table of FIG. 1A in an extended condition and including a portion of the hydraulic lifting mechanism.

FIG. 4C is a schematic front view of the leg and hydraulic lifting mechanism in an unextended or collapsed condition (hidden portions of leg sections are depicted in dashed lines).

FIG. 5A is a top view of an embodiment of a patient table in an expanded configuration with various hidden components depicted in dashed lines.

FIG. 5B is a side view of the patient table of FIG. 5A in an expanded and raised configuration with legs systems unfolded and extended.

FIG. 5C is a front view of the patient table of FIG. 5A in the expanded and raised configuration of FIG. 5B.

FIG. 5D is a front view of the patient table of FIG. 5A in an expanded and lowered configuration with the leg systems unextended (hidden portions of components of the leg systems depicted in dashed lines).

FIG. 5E is a side view of the patient table of FIG. 5A in a partially expanded configuration with the leg systems folded and unextended.

FIG. 5F is a side view of the patient table of FIG. 5A in a fully-collapsed configuration.

FIG. 5H is a perspective line drawing of the patient table of FIG. 5A in the expanded and raised configuration.

FIG. 5I is a perspective rendering of the patient table of FIG. 5A in the expanded and raised configuration.

FIG. 5J is a perspective picture of the patient table of FIG. 5A in the expanded and lowered configuration.

FIG. 5K is a perspective rendering of the patient table of FIG. 5A in the fully-collapsed configuration.

FIG. 6A is a front view of a patient table in a raised configuration with another lifting mechanism.

FIG. 6B is a front view of the patient table of FIG. 6A in a lowered configuration.

FIG. 6C is a top view of the patient table of FIG. 6C with the lifting system depicted in solid lines and upper sections of the patient table depicted in dashed lines.

FIG. 7A is a top view of an embodiment of a patient table in an expanded configuration with various hidden components depicted in dashed lines.

FIG. 7B is a side view of the patient table of FIG. 7A in an expanded and raised configuration with legs systems unfolded and extended. FIG. 7B omits guards of FIG. 7A for clarity.

FIG. 7C is a front view of the patient table of FIG. 7A in the expanded and raised configuration of FIG. 7B.

FIG. 7D is a front view of the patient table of FIG. 7A in an expanded and lowered configuration with the leg systems unextended (hidden portions of components of the leg systems depicted in dashed lines).

FIG. 7E is a side view of the patient table of FIG. 7A in a partially expanded configuration with the leg systems unfolded and unextended.

FIG. 7F is a side view of the patient table of FIG. 7A in a fully-collapsed configuration.

FIGS. 8A-8K include perspective, side, front, back, and bottom views of the patient table of FIG. 7A in various configurations, including an expanded and lowered configuration (FIGS. 8A-C), an expanded and lowered configuration with lowered guards (FIG. 8D), partially collapsed and lowered configuration (FIGS. 8E-8G), and a fully collapsed configuration (FIGS. 8H-8K).

### DETAILED DESCRIPTION

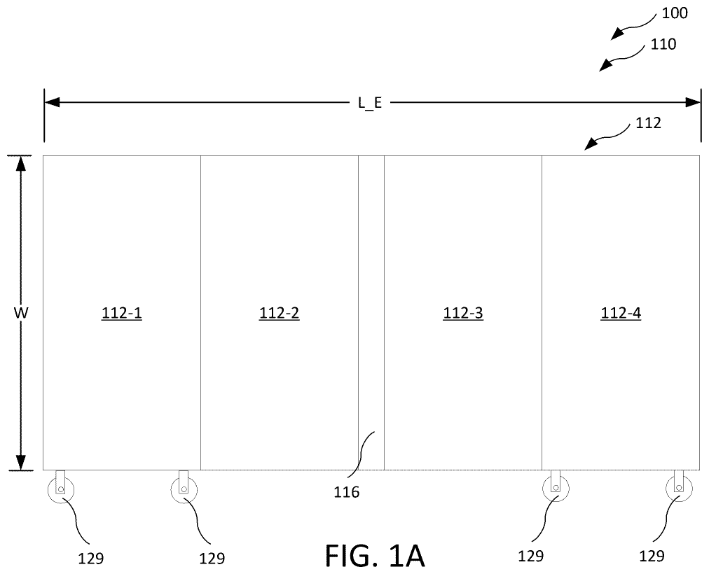

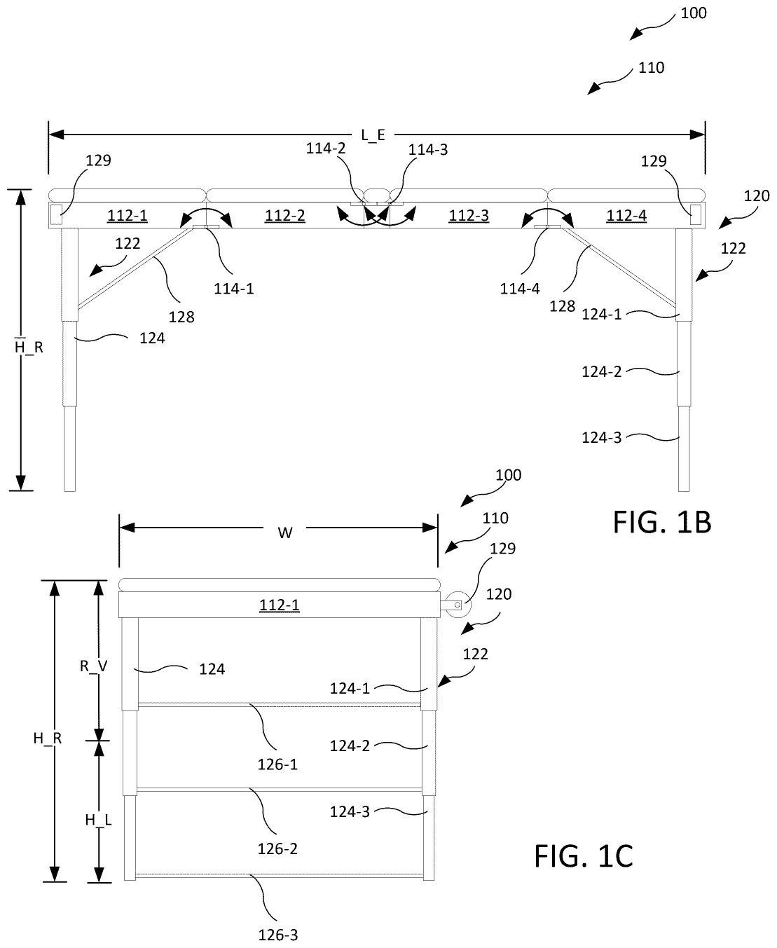

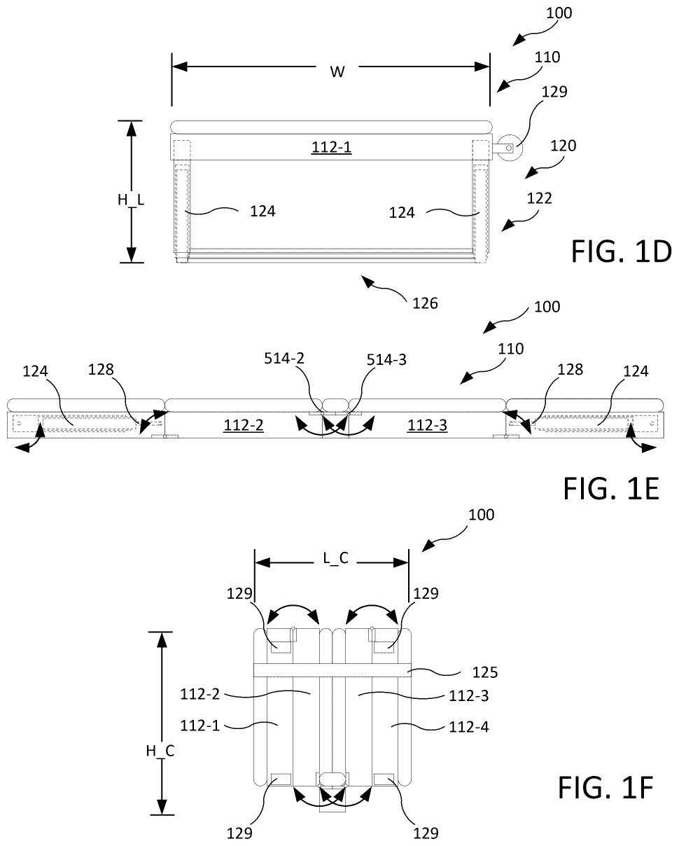

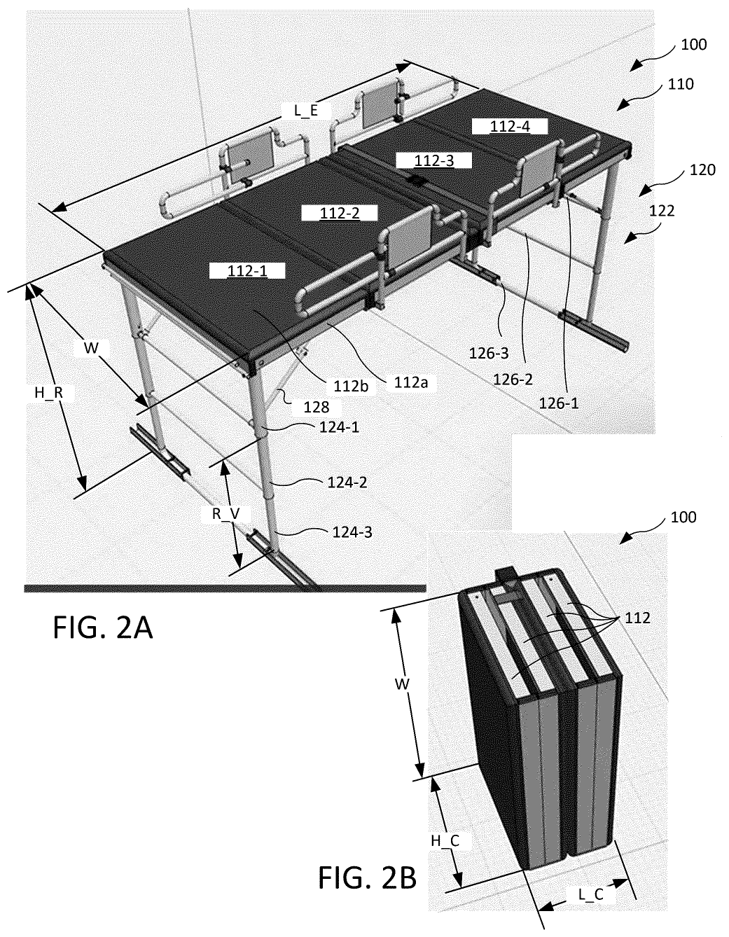

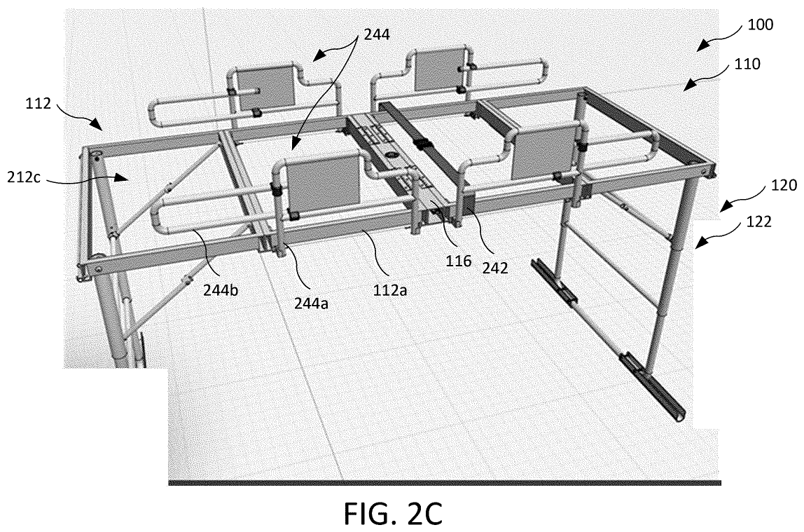

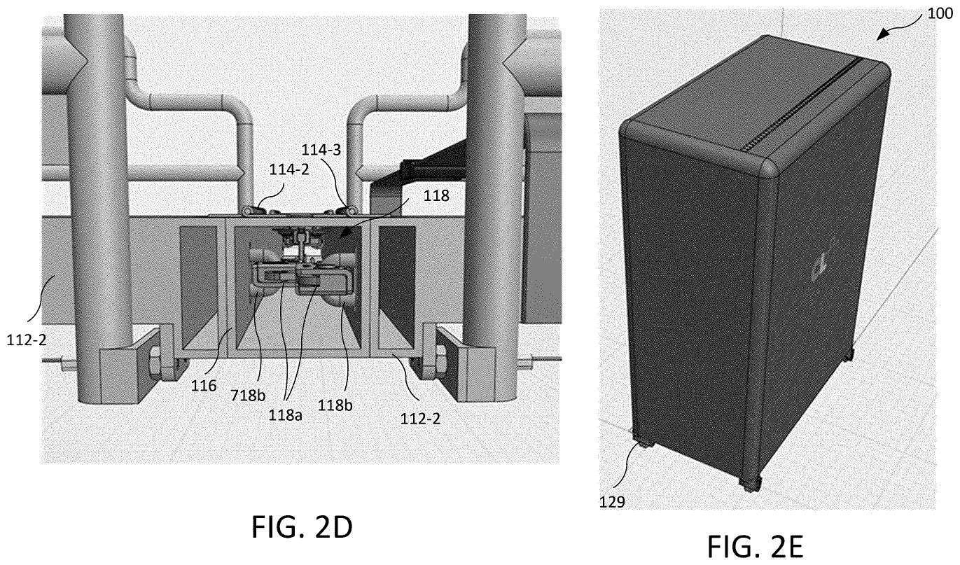

Referring to FIGS. 1A-2C, a patient table 100 is configured for use with adult patients, for example, for a caregiver to change diapers or dressings of the adult patient and cleaning the adult patient. As used herein, the term “adult patient” includes persons weighing up to approximately 250 pounds or more, for example, including fifth percentile females (e.g., a height of 59 inches and a weight of 113 pounds) and ninety-fifth percentile males (e.g., a height of 73 inches and a weight of 246 pounds), depending on studies study according to which the weights and heights of humans are statistically characterized.

The patient table 100 is collapsible, so as to be easily transported within or between locations and for storage. The patient table 100 is further configured to change heights, for example, between a lowered position to facilitate the adult patient moving onto the patient table 100 and raised position to facilitate the caregiver attending to the patient. The patient table 100 is illustrated in an expanded and raised configuration in FIGS. 1A-1C (e.g., a raised in-use configuration), an expanded and lowered configuration in FIG. 1D (e.g., a lowered in-use configuration), a partially expanded configuration with collapsed legs in FIG. 1E, and a fully-collapsed configuration in FIG. 1F (e.g., a transport or storage configuration). When in the fully-collapsed configuration, the patient table 100 is smaller in at least two dimensions as compared to the expanded and raised configuration.

The patient table 100 generally includes an upper structure 110 (e.g., a top or table top) and a lower structure 120 (e.g., a base or base system). In the expanded configuration, the upper structure 110 is configured to engage and support the adult patient thereabove, while the lower structure 120 is configured to support the upper structure 110 and the patient above a ground surface.

The upper structure 110 is formed by upper sections 112. In the expanded configuration, the upper sections 112 of the upper structure 110 generally define an upper surface that engages the patient. The upper surface is generally planar but may include variances of up to approximately three inches to account for compliance (e.g., padding), defined contours (e.g., anatomical recesses that receive portions of patients therein), and spaces between adjacent ones of the sections 112 (discussed in further detail below).

When in the expanded configuration, the patient table 100 has a width W and an expanded length L_E. The expanded length L_E is measured perpendicular to the width W and extends between the outermost portions of the sections 112, which are formed by the ends of the sections 112 when in the expanded configuration. In the expanded configuration, the expanded length L_E is greater than the width W, for example, being between approximately two and four times greater than the width L, such as the width W being approximately 20 to 40 inches (e.g., approximately 30 inches, more, or less) and the length L being approximately 60 to 90 inches (e.g., approximately 70 inches, more, or less). The patient table 110 may further have a weight capacity, for example, of 400 pounds plus a safety factor. The patient table 100 is also configured to have a relatively low weight for portability, such as 80 pounds or less (e.g., 70 pounds or less).

The lower structure 120 includes leg systems 122. In the expanded configuration, the leg systems 122 are configured to support and move the upper structure 110 between a raised height H_R (see FIGS. 1B and 1C) and lowered height H_L (see FIG. 1C) through a vertical range of motion R_V therebetween. The vertical range of motion R_V may, for example, be between five and twenty inches (e.g., approximately twelve inches, more, or less) between the lowered height H_L of between approximately ten and twenty-five inches above the ground (e.g., approximately seventeen inches, more, or less) and the raised height H_R of between approximately twenty-five and forty inches above the ground (e.g., approximately thirty inches, more, or less). The lower support structure 120 may be configured to maintain the upper support surface 110 in a generally horizontal orientation, such that head and foot ends of the upper support surface 110 are raised and lowered synchronously when changing the vertical position of the upper support surface 110.

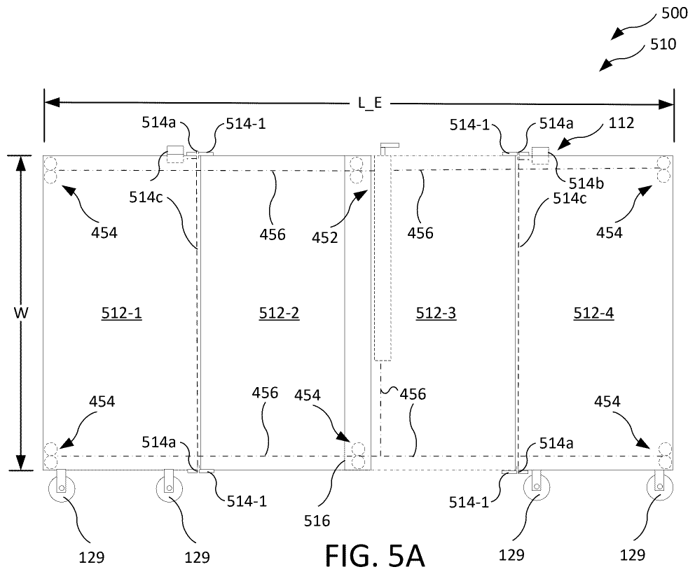

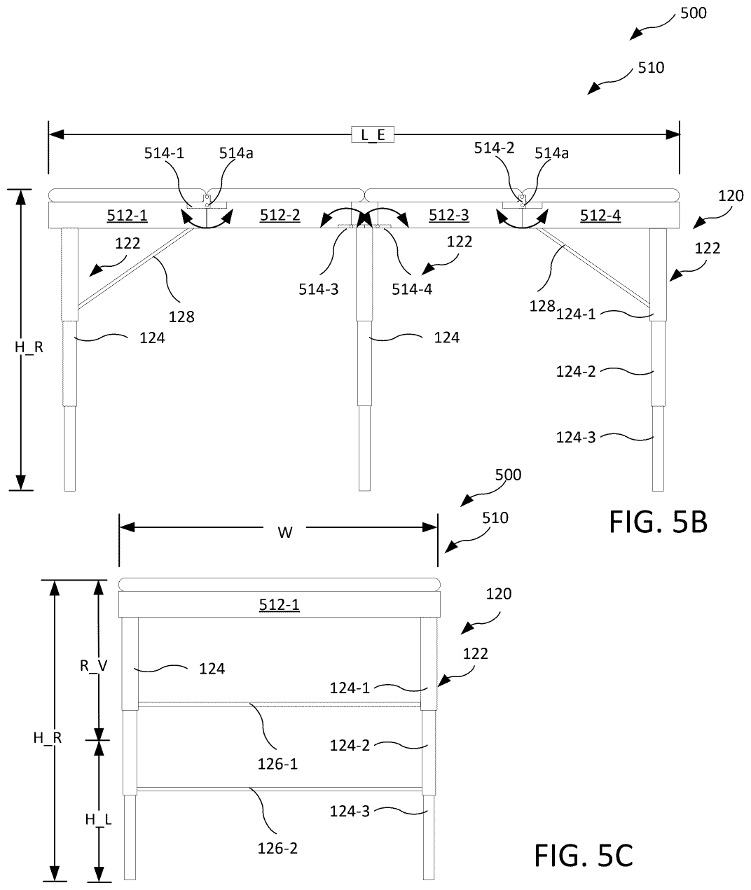

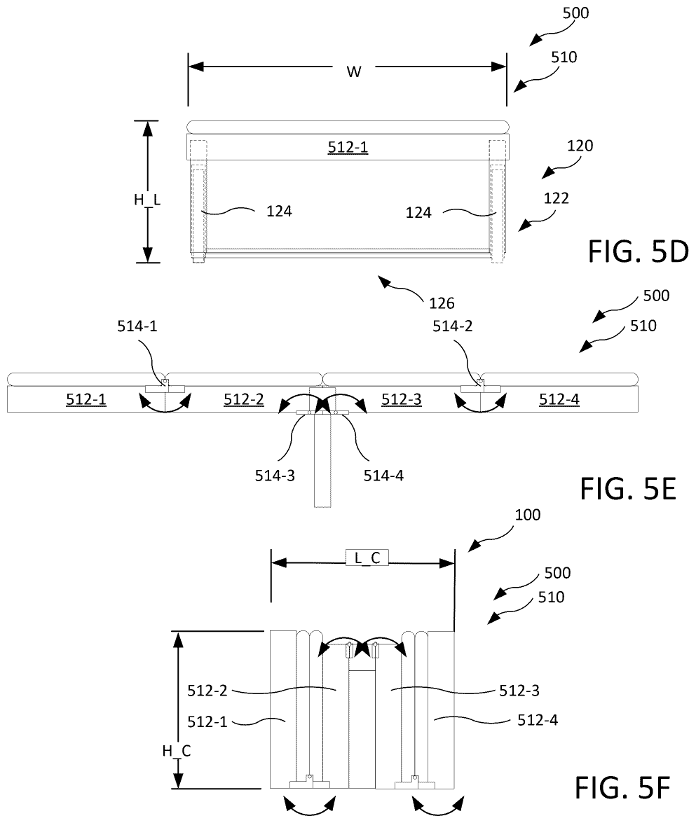

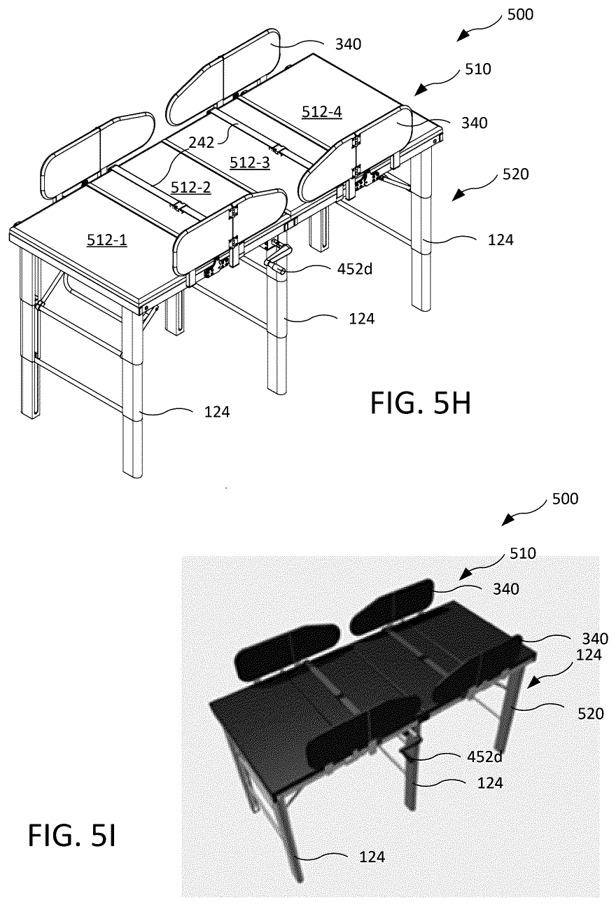

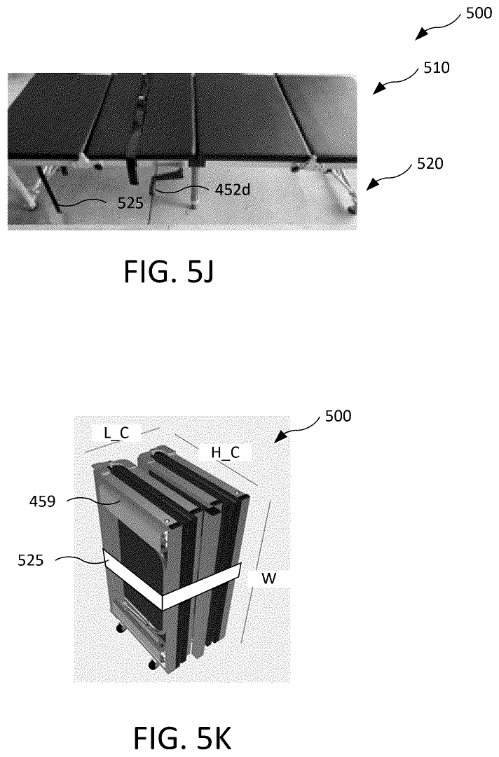

When in the collapsed configuration, the patient table 100 is smaller volumetrically and/or in at least one dimension (e.g., two dimensions) than when in the expanded and raised or lowered configurations. The patient table 100 may have the same width W in both the expanded and collapsed configurations, a collapsed length L_C, and a collapsed height H_C. The collapsed length L_C is also measured perpendicular to the width W and between the outermost portions of the sections 112, which are formed by either upper surfaces (as shown in FIG. 1F) or lower surfaces (as shown in FIG. 5D) of the sections 112 when in the collapsed configuration. The collapsed length L_C is less than in the expanded length L_E, for example, being less than approximately one half, one third, or one fourth of the expanded length L_E (e.g., being less than or equal to one fourth the expanded length L_E), such as between 10 and 15 inches. The collapsed height H_C is less than the raised height H_R, for example, being less than two-thirds of the raised height H_R, such as being between 15 and 25 inches. The collapsed height H_C may be formed predominantly (e.g., 80% or more) by a length of one or more of the upper sections 112. It should be noted that the patient table 100 may include wheels 129 that rest on a ground surface when in the fully collapsed configuration to allow transport of the patient table 100; when so configured and arranged relative to the ground surface, the width W of the patient table 100 is considered to extend vertically and from above the wheels 129. With the wheels, the W may be greater, for example, two to four inches greater than without.

In the collapsed configuration, the upper support surface 110 may further contain or otherwise store other components of the changing table 110, such as the lower support structure 120 and/or lifting systems, partially or wholly, therein or therebetween.

The upper structure 110 generally includes and is formed by the upper sections 112. The upper sections 112 are movable, coupleable, or both relative to each other for reconfiguring the patient table 100 between the expanded configuration and the collapsed configuration. In the expanded configuration, the multiple upper sections 112 cooperatively, alone or in conjunction with one or more intermediate structures (discussed below), span the expanded length L_E of the patient table 100. In the collapsed configuration, the upper structure 110 may generally contain the lower structure 120, for example, with the upper sections 112 containing therein and/or therebetween the leg systems 122. The upper sections 112 may have the same length as each other (i.e., measured parallel with the expanded length L_E of the patient table 100) as shown in FIGS. 1A-IF (e.g., 17.5 inches) or have different lengths as shown in FIGS. 5A-5F (e.g., with the inner or intermediate upper sections 512 being slightly shorter than the outer or end upper sections 512, as discussed in further detail below).

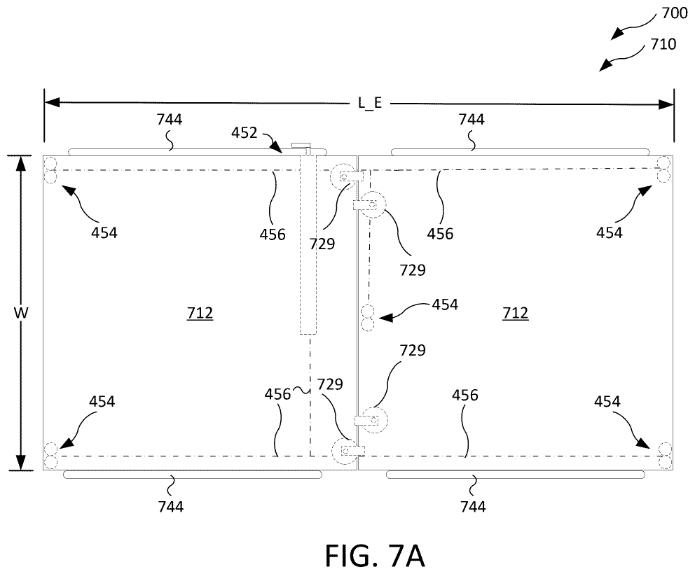

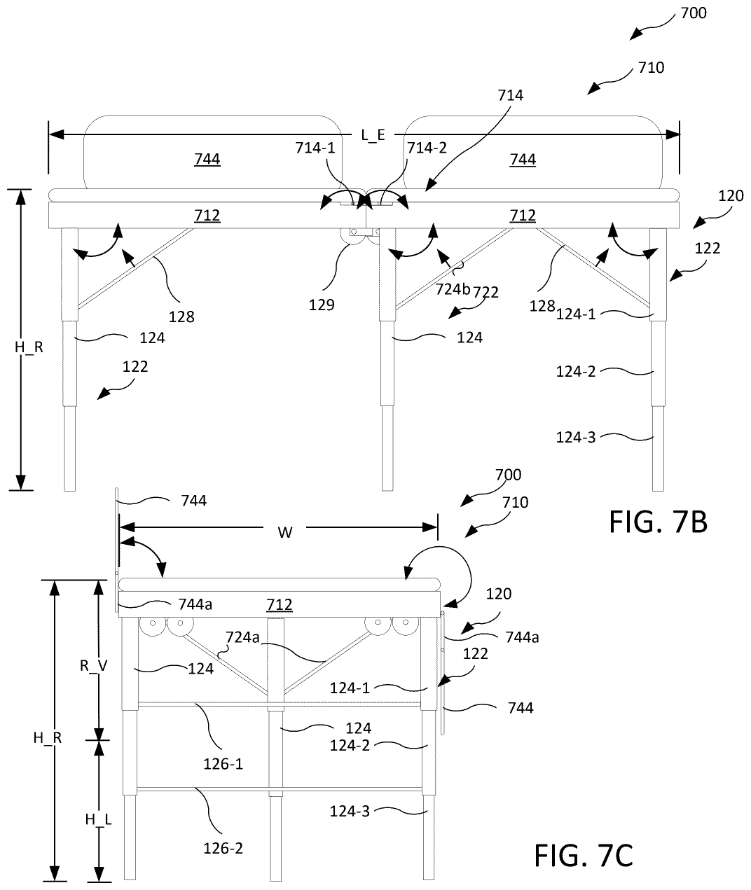

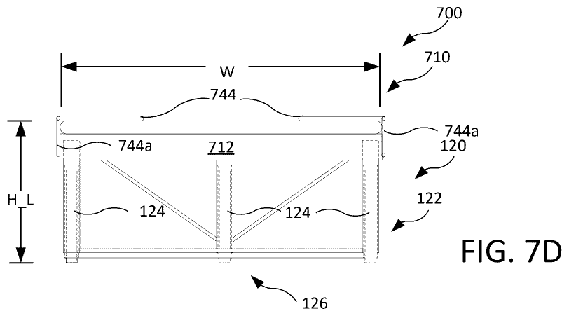

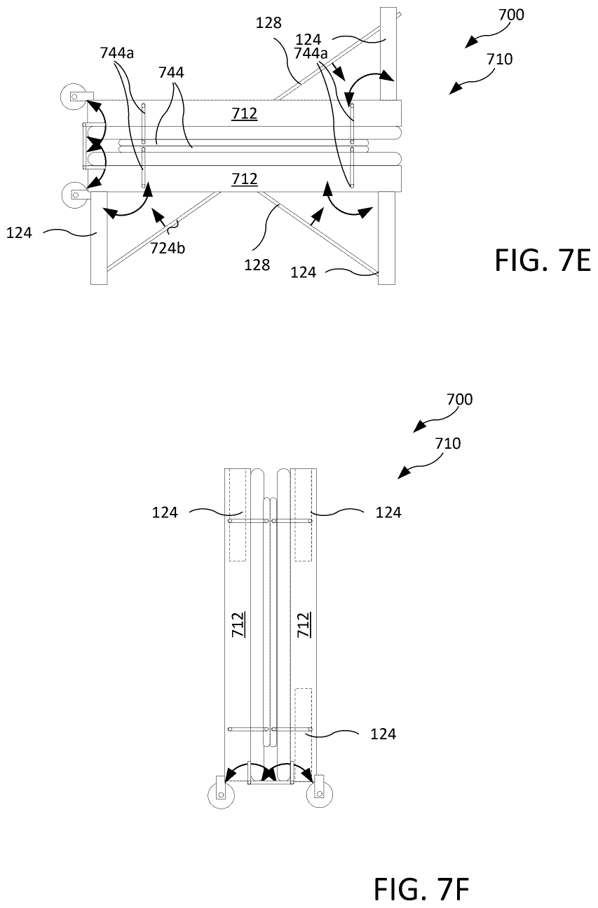

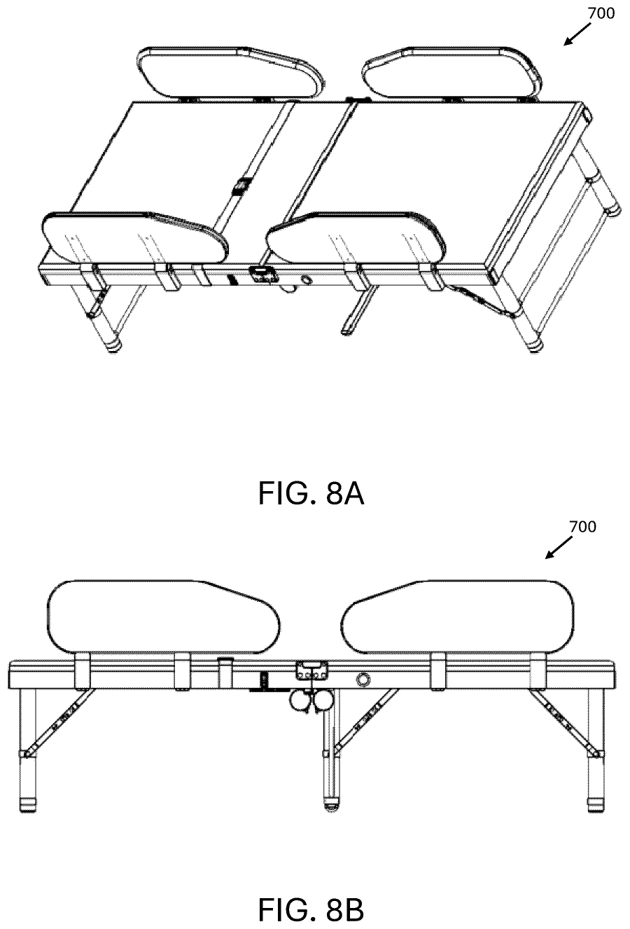

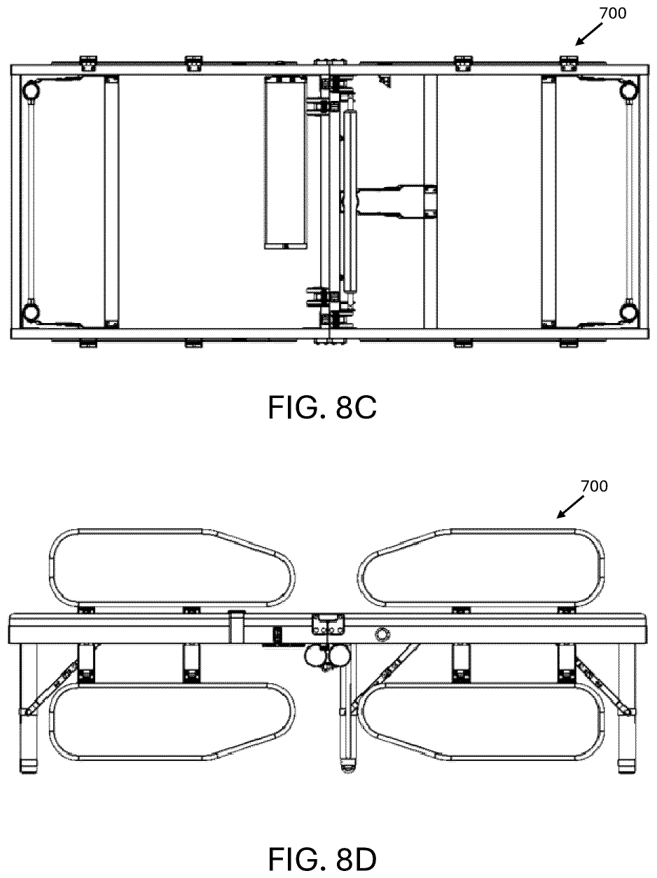

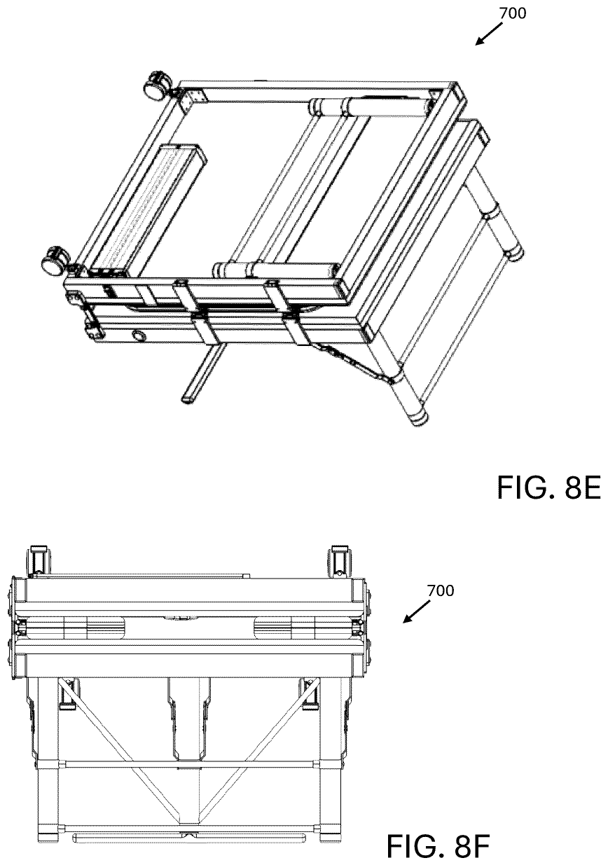

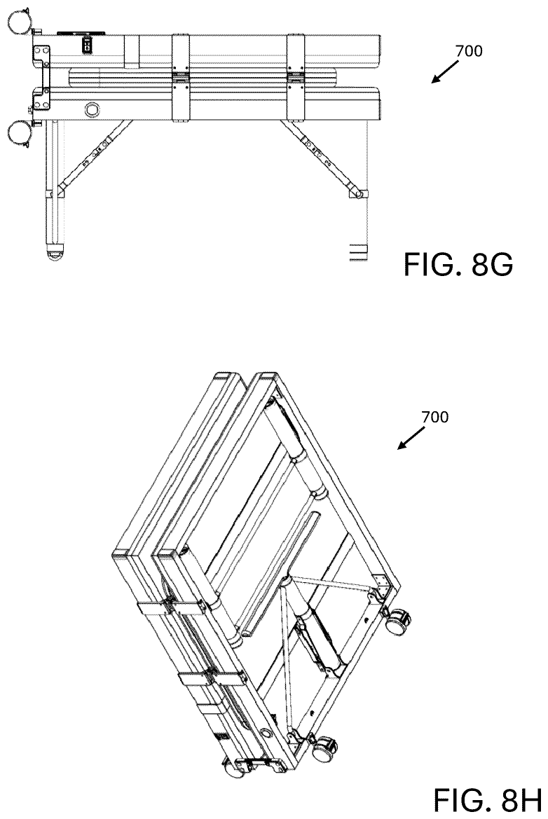

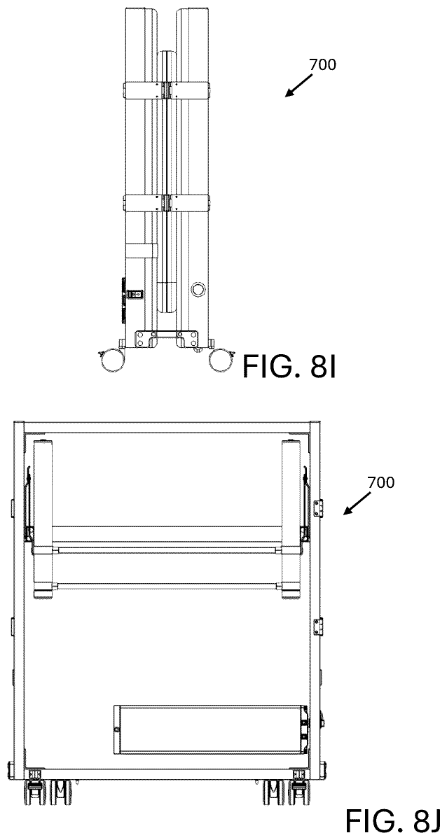

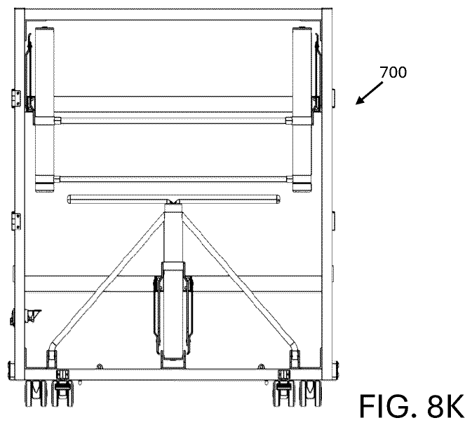

For example, as shown in FIGS. 1A-2C, the upper structure 110 includes four of the upper sections 112, which include a first end upper section 112-1, a first intermediate upper section 112-2, a second intermediate upper section 112-3, and a second end upper section 112-4 that are arranged in series adjacent to each other and pivotably coupled to each other. In this manner, the upper structure 110 is configured to fold from the expanded configuration into the collapsed configuration. When in the expanded configuration, adjacent ones of the upper sections 112 may engage and/or be secured to each other to prevent movement therebetween. In other embodiments, the upper structure 110 of the patient table 100 may include fewer (e.g., two or three) or more (e.g., five or six) of the upper sections 112). For example, the upper structure 110 may instead include only two of the upper structures sections 112 (as shown in FIGS. 7A-7F).

The upper sections 112 are generally rigid structures that cooperatively define the upper surface of the patient table 100. Each of upper sections 112 may, for example, generally include a frame 112a and a platform 112b coupled thereto.

The frame 112a is a generally rigid structure that is coupled to and supports the platform 112b. For example, referring to FIG. 2C, the frame 112a may include frame sections (not separately labeled) that cooperatively define a rectangular shape (e.g., first or head side, second or foot side, left, and right side sections or segments). The frame sections may, for example, be formed of aluminum, another metal, wood, or combinations thereof having suitable cross-sectional shape (e.g., box section) that are coupled to each other to form the frame 112a as a rigid structure (e.g., using fasteners). In one example, the frame sections of the frame 112a are rectangular section aluminum tubing, such as 1.5 inches by 0.75 inches.

The platform 112b of each of the upper sections 112 is a generally planar structure that is coupled to an upper side of the frame 112a or recessed therein, or alternatively may be substantially planar while including contours to accommodate the patient when positioned thereon The platform 112b may, for example be formed of wood (e.g., plywood, oriented strand board, plastic) or other generally rigid material suitable for supporting a portion of the patient on the frame 112a (e.g., distributing weight of the patient to the frame 112a). The platform 112b may further include soft and/or cleanable materials, such as a padding material (e.g., a foam) and/or a cover material (e.g., vinyl) over the rigid material and/or the padding material. The padding may be generally uniform in thickness or contoured, for example, to accommodate portions of patients' bodies.

The frame 112a and the platform 112b may further define a cavity 212c between the frame segments and below the platform 112b into which portions of the lower structure 120, such as the leg systems 122, are received in the collapsed configuration.

Instead of the frame 112a and the platform 112b being components that are separately formed and coupled to each other, the platform 112b may instead be formed so as to be a self-supporting structure without need for a separate frame 112a (e.g., a blow-molded plastic component with structural features formed therewith).

When in the expanded configuration, bottom surfaces of the upper sections 112 are generally parallel with each other, coplanar with each other, or both (as shown). In the embodiment shown in FIGS. 1A-2C, when the patient table 100 is in the collapsed configuration, the bottom surfaces of the upper structures 112 on each side of the upper structure 110 are parallel with and face each other (i.e., bottom surfaces of the first end and intermediate upper sections 112-1, 112-2 and bottom surfaces of the second and intermediate upper sections 112-3, 112-4), while upper surfaces of the upper structures 112 in a middle of the upper structure 110 are parallel with and face each other (i.e., the first and second intermediate upper sections 112-3, 112-4). Other configurations and collapsing of variations the patient table 100 are discussed below with respect to FIGS. 5A-5K and FIGS. 7A-7F.

As shown, on the first side of the patient table 100 (e.g., the head side), the first end upper section 112-1 and the first end intermediate section 112-2 are pivotably coupled to each other to pivot relative to each other about a single pivot axis, such as a first side pivot axis. From the expanded to the collapsed configuration, the first-side end section 112-1 and the first-side intermediate section 112-2 rotate downward relative to each other, for example, with the first side pivot axis formed by a first side hinge 114-1 coupled to and adjacent bottom portions of the frames 112a thereof. The first side hinge 114-1 may define the pivot axis to be substantially coplanar with the bottom surfaces of the frames 112a. For example, the first side hinge 514-1 may be a piano hinge (as shown) or another type of hinge (e.g., a knife hinge). When in the collapsed configuration, the bottom surfaces of the frames 112a of the upper sections 112-1, 112-2 are parallel with and face each other, for example, contacting each other (as shown in FIG. 1F). When in the expanded configuration, the bottom surfaces of the upper sections 112-1, 112-2 are parallel with and adjacent to each other (e.g., being coplanar as shown in FIGS. 1B and 1C). When in the expanded configuration, vertical end surfaces of the frames 112a may engage each other to prevent further upward rotation and maintain the parallel and/or coplanar relationships between the upper sections 112-1, 112-2 (e.g., between the bottom and/or upper surfaces thereof).

The second side of the upper structure 110 is configured similar to the first side with the second side end section 112-4 and the second side intermediate section 112-3 being pivotably coupled to each other with a second side hinge 114-4 in substantially the same manner as the first end section 112-1 and the first side intermediate section 112-2 with the first side hinge 114-1.

In the middle of the upper structure 110, the first-side intermediate section 112-2 and the second-side intermediate section 112-3 are configured to rotate upward toward each other from the expanded configuration to the collapsed configuration. In the expanded configuration, the bottom surfaces of the upper sections 112-2, 112-3 are parallel with each other, coplanar with each other, or both. In the collapsed configuration, the bottom surfaces of frames 112a of the upper sections 112-2, 112-3 are parallel with and face away from each other and are spaced apart. In the collapsed configuration, the upper surfaces of the platforms 112b are parallel with and face toward each other (e.g., contacting each other).

The frames 112a of the upper sections 112-2, 112-3 are pivotably coupled to each other with sufficient space therebetween to receive the platforms 112b therebetween in the collapsed configuration. For example, as shown, the frames 112a of the first side intermediate section 112-2 and the second-side intermediate section 112-3 are each pivotably coupled to an intermediate member 116 with first and second intermediate hinges 114-2, 114-3. The intermediate member 116 may have a length that is measured parallel with the expanded length L_E of the upper structure 110 that is approximately equal to a sum of the thicknesses of the platforms 112b of the upper sections 112-2, 112-3 and is less than the length of one or more of the upper sections 112 (e.g., being less than ¼, ⅙, the length thereof measured parallel with the expanded length L_E). The intermediate member 116 may have a thickness (measured vertically) that is the same as a thickness of the frames 112a of the upper sections, for example, being a rectangular section aluminum tube (e.g., 1.5 inches by 1.5 inches). The hinges 114-2, 114-3 form a pair of pivot axes that are parallel with each other and the other pivot axes formed by the hinges 114-1, 114-4 and that are spaced apart from each other the sum of the thicknesses of the platforms 112b of the upper sections 112-2, 112-3.

Referring to FIG. 2D, the patient table 100 may include one or more securing mechanisms that selectively secure the upper sections 112 to each other in the expanded configuration to prevent rotation therebetween.

In the middle of the upper structure 110, a securing mechanism 118 may selectively secure the intermediate upper sections 112-2, 112-3 and the intermediate member 116 to prevent downward rotation of the intermediate upper sections 112-2, 112-3 relative to each other. As shown in FIG. 2D, in one example, the securing mechanism 118 is a latch system that includes one or more latches 118a coupled to the intermediate member 116 (e.g., being disposed therein) that receives and releasably couples to strikers 118b that are fixedly coupled to the first-side intermediate section 112-2 and the second-side intermediate section 112-3. The securing mechanism 118 may be configured in different manners, for example, using slide pins that are contained in one of the sections 112 and that are slid into adjacent sections 112 and resist torque applied thereto by the two sections 112 (e.g., as described for the pins 514a and actuator 514b below).

On the sides of the upper structure, similar securing mechanisms may be implemented to prevent upward rotation of the upper sections 112 relative to each other (i.e., to prevent rotation between the first side end and intermediate sections 112-1, 112-2 and between the second side end and intermediate sections 112-4, 112-3).

As discussed in further detail below, the upper structure 110 of the patient table 100 may be configured in other manners (e.g., to collapse in different manners), as shown in FIGS. 5A-5F and discussed in further detail below.

Referring still to FIGS. 1A-2C, the lower support structure 120 is configured to support the upper structure 110 when the patient table 100 is in the expanded configuration and is further configured to be contained within the upper sections 112 when in the collapsed configuration. As also referenced above and discussed in further detail below, the lower support structure 120 is further configured to raise and lower the upper support 110 between a lower position and a raised position over a vertical range of motion R_V.

As shown in FIGS. 1B-1E, 2A, and 2C, the lower support structure 120 includes two of the leg systems 122. A first leg system 122-1 and a second leg system 122-2 are arranged, respectively, at the first end (i.e., the head end) and the second end (i.e., the foot end) of the patient table 100. As shown in FIGS. 5A-5F, a patient table 500 is a variation of the patient table 100 and may include a third leg system 122, and in FIGS. 7A-7F a patient table 700 is a variation of the patient table 100 that includes a third leg system different than that of the patient table 500.

Each of the leg systems 122 includes two legs 124 (e.g., a left leg and a right leg) that are configured to expand and collapse, for example, linearly and/or over a distance equal to the vertical range of motion R_V. As shown, each of the legs 124 may be configured to expand and collapse telescopically, for example, including an upper leg section 124-1 within which slides a middle leg section 124-2 and in turn within which slides a lower leg section 124-3. As shown in FIGS. 7A-7F, a third leg system 722 may include only one of the legs 124.

Each of the leg systems 122 further includes cross members 126 that are configured to prevent lateral movement of the two legs 124 thereof relative to each other. As shown, for example, the leg system 122 may include cross members 126 that are coupled to and extend between the lower ends of the leg sections of the legs 124. Each of the leg systems 122 may include cross members 126 corresponding in quantity to that of the sections of each of the legs 124. For example, each of the leg systems 122 includes three of the cross members 126 and, in particular, include an upper cross member 126-1 that is coupled to and extends between lower ends of the upper leg sections 124-1, a middle cross member 126-2 that is coupled to an extends between lower ends of the middle leg sections 124-2, and a lower cross-member 126-3 that is coupled to and extends between lower ends of the lower leg sections 124-3. Alternatively, as shown in FIGS. 5A-5F, the leg systems 122 may include fewer cross members (e.g., one less than the number of sections of each of the legs 124, for example, omitting the lower cross member 126-3). As a still further alternative shown in FIGS. 7A-7F, a third and central one of the leg systems 722 may include a single one of the legs 124 that includes stabilizing members that connect the upper structure 712 to provide lateral stability.

Each of the leg systems 122 is configured to move between an extended and unfolded configuration (as shown in FIGS. 1B, 1C, 2A, and 2C in which the patient table 100 is raised), an unextended and unfolded configuration (as shown in FIG. 1D in which the patient table 100 is lowered), and an unextended and folded configuration (as shown in FIGS. 1E and 1F in which the patient table 100 is partially or fully collapsed). More particularly, one of the leg systems 122 is pivotably coupled to the head end of the first-side upper end section 112-1 and another of the leg systems 122 is pivotably coupled to a foot end of the second-side end section 112-4. In the unfolded configurations, whether extended or unextended, each of the leg systems 122 extends downward, for example, substantially perpendicular to the upper support 110 and/or such that the legs 124 of the different leg systems 122 extend and collapse (e.g., telescope) vertically and parallel to each other. In the folded and unextended configuration (e.g., a collapsed configuration), the leg system 122 is pivoted toward the upper support section 112-1, 112-4 and, with the legs 124 also collapsed, is received generally within the frame of the upper section 112-1, 112-4.

The leg system 122 further includes one or more braces 128 that are configured to selectively hold the leg systems 122 in the unfolded position and allow the leg system 122 to move to the folded position. A first end (e.g., an upper end) of the brace 128 is pivotably coupled to the upper section 112-1, 112-4 generally opposite to the location at which the legs 124 are pivotably coupled thereto. A second end (e.g., a lower end) of the brace 128 is fixedly, movably, or releasably coupled to leg system 122, for example, to a lower end of the upper leg section 124-1 (as shown in FIGS. 1B, 2A, and 2C) or to the upper cross member 126-1 (not shown). In the case of the brace 128 being fixedly coupled to the leg system 122, the brace 128 may itself selectively collapse (e.g., fold) to permit the leg system 122 to move from the extended to collapsed position, as shown in FIGS. 2A and 2C in which the brace 128 has a center pivot joint (shown; not labeled). The brace 128 may include a stop that prevents downward rotation of the brace past the two sections being parallel (e.g., prevents hyperextension of the brace 128 about its pivot joint). In the case of the brace 128 being slidably coupled to the leg system 122, the brace 128 is configured to selectively slide along the leg system (e.g., having slot therealong and within which a post fixedly coupled to the leg system 122 slides and locks in the extended position, or sliding within a sleeve that is fixedly coupled to the leg system 122 and locks in the extended position). In the case of the brace being releasably coupled to the leg system 122, the lower end of the brace disconnects from the leg system 122 to allow the leg system 122 to pivot from the extended position into the collapsed position.

Referring to FIGS. 1A-1D, 1F, and 2E, the upper sections 112 of the patient table 100 may further include wheels 129 that are coupled to and extend laterally from either a left side or a right side of the frames 112a of the first end upper section 112-1 and the second end upper section 112-4. When the table is in the collapsed configuration, the wheels 129 are arranged proximate four corners of the patient table 100, thereby allowing the patient table 100 to rest stable on the ground surface via the wheels 129 and be moved across the ground surface (see FIG. 2E). The patient table 100 may further include a cover 127 that encloses the patient table 100 in the collapsed configuration and from which the wheels 129 protrude, for example, with the cover 127 including an open side that corresponds to the wheels 129. The patient table 100 may still further or instead of the cover 127 include a strap 525 that retains the patient table 100 in the collapsed configuration (see FIG. 5K).

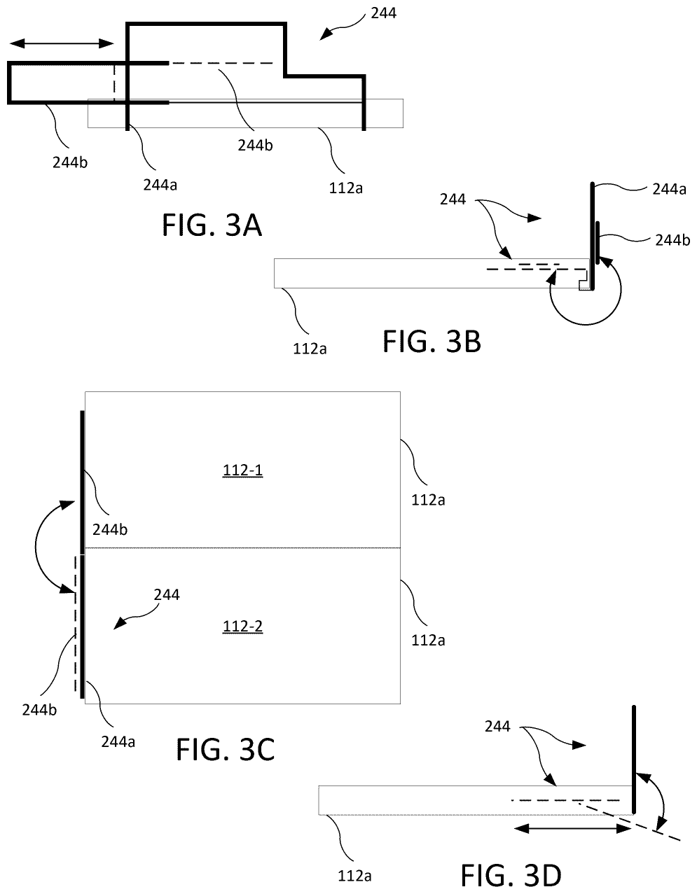

Referring more particularly to FIGS. 2A, 2C, 3A, and 3B, the patient table 100 is further configured to help retain the adult patient on the upper structure 110. As shown, the patient table 100 may further include one or more straps 242 that are coupled to one of the intermediate upper sections 112-1, 112-2 and extends from left to right sides of thereof and over the patient (see also FIG. 5H). The patient table 700 may also include one or more the straps 242 coupled to the upper sections 712 thereof.

The patient table 100 may further include one or more guards 244 (e.g., rails or railings) that, when in use, are configured to extend upward from the side of the upper structure 110. When not in use, the one or more guards are configured to be stored within the cavity 212c of the upper section to which it is coupled. As shown, the guard 244 generally includes a first guard portion 244a and a second guard portion 244b. The guard 244 may further include a cover (e.g., a pad; not shown) on the first guard portion 244a and/or the second guard portion 244b. The first guard portion 244a is rigid and extends a portion (e.g., a majority, such as 75% or more) of the length of the upper section 112 to which it is coupled. When in use, the first guard portion 244a extends upward a height that may, for example, be between 6 and 12 inches above the upper surface of the upper section 112, and which may vary over the length thereof (e.g., being stepped with two or more different heights). The second guard portion 244b is movably coupled to the first guard portion 244a, such that the guard 244 is expandable between collapsed configuration having a collapsed length that is less than that of the upper section 212 to which it is couples and an expanded configuration having an extended length that is greater than that of the upper sections 212. The extended length of the guard 244 may, for example, be 1.5 times greater or more than the collapsed length (see FIG. 3A; collapsed shown in dashed lines)). As shown, the second guard portion 244b is configured to slide longitudinally relative to the first guard portion 244a (i.e., in the direction of the extended length L_E of the patient table 100) but may instead be configured to pivot relative thereto.

The guard 244 is further configured to be received and stored in the cavity 112c defined by the frame 112a of the upper section 112. As shown in FIG. 3B, the guard 244 may be pivotably coupled to the frame 112a with a hinge (depicted schematically; not labeled) so as to rotate approximately 270 degrees (e.g., +/−5 degrees) between the in-use position and a stowed position (stowed shown in dashed lines). For example, pivot axis of the hinge may be located inboard of the side of the frame 112a of the upper section, such that the guard 244 and the hinge are contained within the cavity 112c of the frame 112a of the upper section 112.

The guard 244 may be further configured to lock or otherwise secure in the in-use (i.e., upright position) and stowed positions, for example, using sprung pins or other suitable locking mechanism.

Referring to FIG. 3C, the guard 244 may be instead configured such that the second guard portion 244b is pivotable relative to the first gourd portion 244a between the collapsed configuration (depicted in dashed lines) and the extended configuration (solid lines). See also FIGS. 5H and 5I).

Referring to FIG. 3D, the guard 244 may be configured instead to articulate or slide and pivot (e.g., approximately 90 degrees) from the stowed position to the in-use position, such that the most outboard portion of the guard 244 in the stowed position is the uppermost portion of the guard 244 in the in-use position.

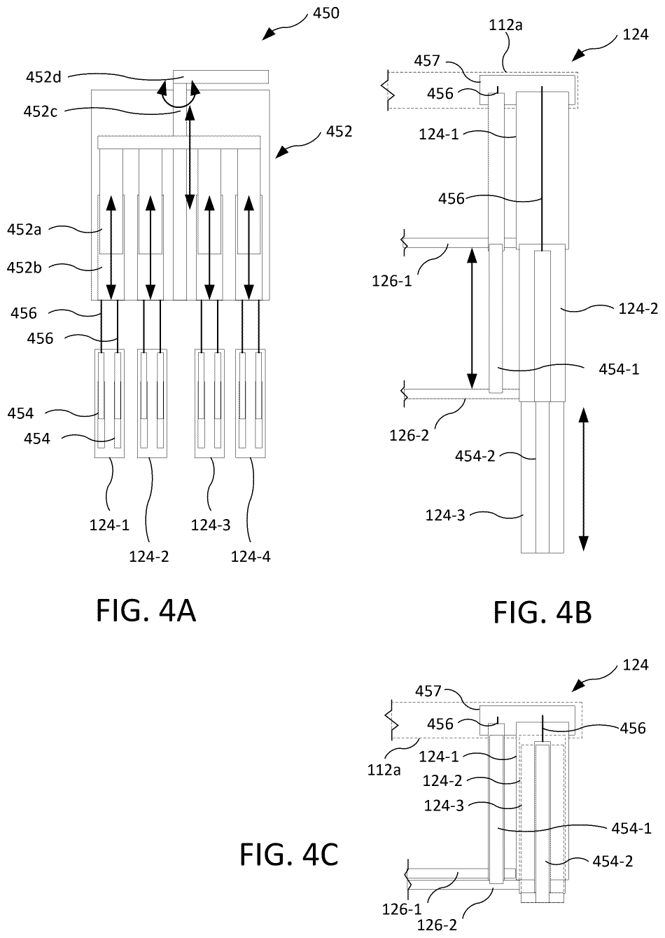

Referring to FIGS. 4A-4C, the patient table 100 includes a lifting system 450 that is configured to raise the upper structure 110 from the lowered position to the raised position. The lifting system 450 interfaces with the leg systems 122, such that the leg sections 124-1, 124-2, 124-3 of the legs 124 extend and collapse relative to each other (e.g., telescopically). In FIG. 4A, the lifting system 450 is depicted schematically. In FIGS. 4B and 4C, a portion of the lifting system 450 is depicted in association with a leg 124 of the lower structure 120 in an extended configuration (FIG. 4B) and an unextended configuration (FIG. 4C). In FIGS. 4B and 4C the frame 112a of the upper section 112 is depicted in dashed lines in order to better illustrate components positioned therein.

In a first variation, the lifting system 450 is hydraulic and generally includes a hydraulic pump 452, hydraulic actuator cylinders 454, and hydraulic lines 456 fluidically connecting the hydraulic pump 452 with the hydraulic actuator cylinders 454. The hydraulic pump 452 is generally configured to move a hydraulic fluid through the hydraulic lines 456 to the hydraulic actuator cylinders 454. The hydraulic actuator cylinders 454 are configured with the legs 124 and the leg sections thereof to cause extension and retraction thereof as the hydraulic fluid is pumped therein.

The lifting system 450 includes one or more hydraulic actuator cylinders 454 for each of the legs 124 and, more particularly, includes one hydraulic cylinder for each of the leg sections thereof that are moved relative to another leg section thereof. Each of the hydraulic actuator cylinders 454 is mechanically connected to two of the leg sections and causes expansion and permits retraction therebetween as the hydraulic fluid is received by or exits the hydraulic actuator cylinder 454.

In the patient table 100, each of the four legs 122 includes the upper, middle, and lower leg sections 124-1, 124-2, 124-3 of which the middle leg section 124-2 moves relative to the upper leg section 124-1 and the lower leg section 124-3 moves relative to the middle leg section 124-2. Thus, each leg 124 includes a first or upper hydraulic actuator cylinder 454-1 and a second or lower hydraulic actuator cylinder 454-2. The upper hydraulic actuator cylinder 454-1 is coupled to the upper leg section 124-1 and the middle leg section 124-2 and causes the middle leg section 124-2 to move relative to the upper leg section 124-1. The lower hydraulic actuator cylinder 454-2 is coupled to the middle leg section 124-2 and the lower leg section 124-3 and causes the lower leg section 124-3 to move relative to the middle leg section 124-2.

More particularly, the lower hydraulic actuator cylinder 454-2 is generally contained within the lower leg section 124-3, while the upper hydraulic actuator cylinder 454-1 is positioned outside the leg 122. The upper hydraulic actuator cylinder 454-1, for example, extends from the upper section 112 (e.g., a hinge 457 by which both the upper leg section 124-1 and the upper hydraulic actuator cylinder 454-1) to the middle cross member 126-2 that is coupled to a lower end of the middle leg section 124-2. The upper hydraulic actuator cylinder 454-1 may be covered by a sheath 459 or other covering (see FIG. 5K). Alternatively, the hydraulic actuator cylinders 454 are contained within the legs 124. For example, when in the collapsed position, the hydraulic actuator cylinders 454 may be positioned adjacent to each other within the leg 124 (e.g., within the lower leg section 124-3).

The lifting system 450 defines one or more fluid circuits that are fluidically isolated from each other. In a preferred example, the lifting system 450 includes one fluid circuit for each of the legs 124, which includes the two hydraulic actuator cylinders 454 and the hydraulic lines 456 connecting the hydraulic actuator cylinders 454 to the hydraulic pump 452. In this manner, the hydraulic actuator cylinders 454 associated with each one of the legs 124 have a common fluid pressure.

The hydraulic pump 452 causes the hydraulic fluid to flow volumetrically equally to each of fluid circuits and the hydraulic actuator cylinders 454 thereof. As a result, with the hydraulic fluid being substantially incompressible, the hydraulic pump 452 causes the hydraulic actuator cylinders 454 and thereby the legs 124 associated therewith to expand equal distances at equal rates despite each of the legs 124 supporting a different amount of weight of the patient.

As shown, the hydraulic pump 452 generally includes pump cylinders 452a and pump pistons 452b that slide within the pump cylinders 452a to move the hydraulic fluid therein. Each of the pump cylinders 454a is fluidically coupled to the hydraulic lines 456 of one of the fluid circuits and, thereby, the hydraulic actuator cylinders 454 of the fluid circuit. The hydraulic pump 452 is configured to move the pump pistons 452b within the pump cylinders 452a simultaneously at the same rate, such that the hydraulic fluid is displaced equally therefrom. For example, the pump pistons 452b are mechanically linked, for example, being pressed a common distance by a lead screw 452c of the hydraulic pump 452. As shown, the hydraulic pump 452 is manually operated with a hand turn 452d (e.g., a hand crank) that rotates the lead screw 452c to cause the movement of the pump pistons 452b and, thereby, displacement of the hydraulic fluid through the lines to the hydraulic actuator cylinders 454. As an alternative, the hydraulic pump 452 may be electrically operated, for example, using an electric motor to rotate the lead screw 452c (e.g., instead of or in addition to the hand crank 452d). In such case, the electric motor may be powered by a building (having a cord that plugs into an outlet of the building) and/or a battery. The electric motor may be controlled in any suitable manner (e.g., buttons to control rotation of the lead screw 452c in each direction).

The hydraulic pump 452 may, for example, be contained within one of the cavities 112c of the upper section 112 of the upper structure 110, for example, within one of the upper sections that does not include one of the leg systems 122 coupled thereto (e.g., the first side intermediate section 112-2 shown in FIG. 1B or 312-2 shown in FIG. 3B below). The hydraulic lines 456 extend from the hydraulic pump 452 through the various upper sections 112 to the legs 124 and the hydraulic actuator cylinders 454 contained or otherwise operatively coupled thereto. The hydraulic lines 456 are flexible, so as to bend as the upper sections 112 are pivoted (e.g., folded) relative to each other and as the legs 124 are pivoted (e.g., folded) relative to the upper sections 112. As shown in FIGS. 7A-7F, in variations of the patient table 100 in which one of the cavities 112c stores more of the leg systems 122, the hydraulic pump 452 may be positioned in another of the cavities 112c of the upper sections 112.

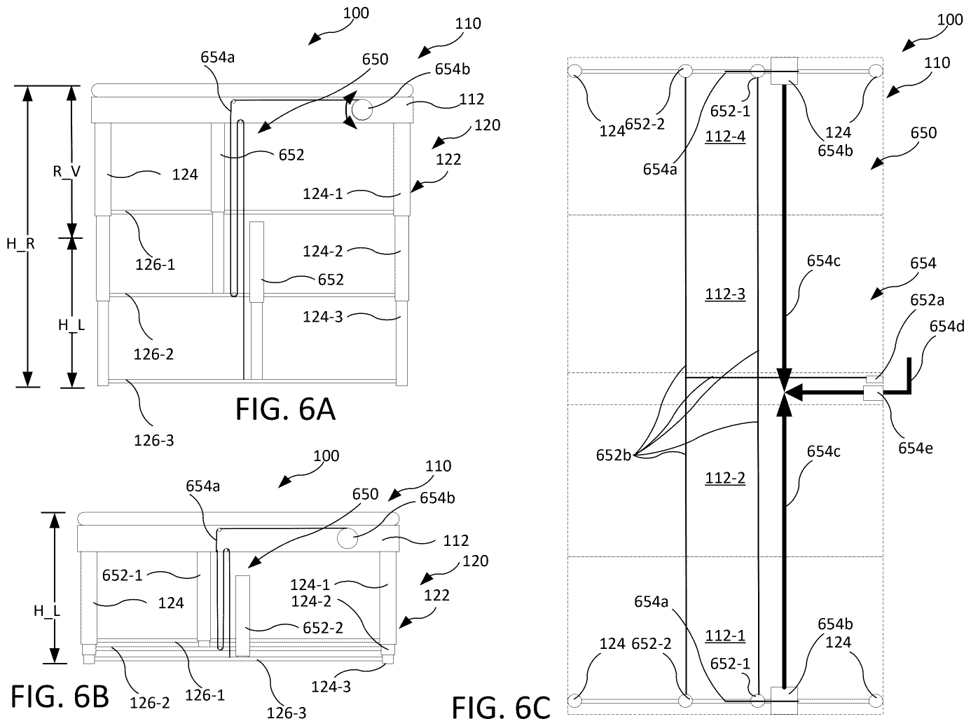

Another lifting system is discussed in further detail below with respect to FIGS. 6A-6C, which may be utilized with the patient table 100 or the patient table 500.

Referring to FIGS. 5A-5H, a patient table 500 is a variation of the patient table 100, which includes an upper structure 510 that is a variation of the upper structure 110 and a lower structure 520 that is a variation of the lower structure 120. The upper structure 510 includes upper sections 512 and an intermediate member 516 that are structured as generally described above for the upper sections 112 (e.g., including the frames 112a and the platforms 112b) and the intermediate member 116, respectively, while also being configured to be arranged differently in the collapsed configuration and move differently between the expanded and collapsed configurations. The lower structure 520 includes leg systems 522 that may be generally configured as described above for the leg systems 122 and may further include a central leg system 522 arranged proximate a middle portion of the patient table 500 along the extended length L_E thereof, for example, being rigidly coupled to the intermediate member 516.

When in the expanded configuration, bottom surfaces of the upper sections 512 are generally parallel with each other, coplanar with each other, or both (as shown). In the collapsed configuration, the bottom surfaces of the upper sections 512 on each side of the upper structure 510 are parallel with and face away from each other (e.g., being separated by the frames 112a thereof), while upper surfaces of the upper sections 112 in the middle of the upper structure 110 are parallel with and face toward each other (e.g., contacting each other).

From the expanded to the collapsed configuration, the first-side end section 512-1 and the first-side intermediate section 512-2 rotate upward relative to each other, for example, with the first-side pivot axis formed by one or more first side hinges 514-1 (e.g., two hinges on left and right sides of the upper structure 510). The first side pivot axis is positioned above the frames 112a of the upper sections 512-1, 512-2, such that in the collapsed configuration the frames 112a are spaced apart to receive the platforms 112b therebetween. The first side hinges 514-1 may, for example, be knife hinges. When in the collapsed configuration, the bottom surfaces of the frames 112a of the upper sections 512-1, 512-2 are parallel with each other and face away from each other (as shown in FIG. 3F). When in the expanded configuration, the bottom surfaces of the upper sections 512-1, 512-2 are parallel with and adjacent to each other (as shown in FIGS. 3B and 3C). When in the expanded configuration, vertical end surfaces of the frames 112a or bumpers thereon may engage each other to prevent further downward rotation and maintain the parallel and/or coplanar relationships between the upper sections 512-1, 512-2 (e.g., between the bottom and/or upper surfaces thereof).

The second side of the upper structure 510 is configured similar to the first side with the second side end section 512-4 and the second side intermediate section 512-3 being pivotably coupled to each other with second side hinges 514-2 in substantially the same manner as the first end section 512-1 and the first side intermediate section 512-2 with the first side hinges 514-1.

In the middle of the upper structure 510, the first-side intermediate section 512-2 and the second-side intermediate section 512-3 are pivotably coupled to each other via the intermediate member 516. More particularly, the first-side intermediate section 512-2 and the second side intermediate section 512-3 are pivotably coupled to the intermediate member 516 to pivot relative thereto about intermediate pivot axes formed by hinges 514-3, 514-4 (e.g., piano hinges) downwardly when moving from the expanded to collapsed configuration. The intermediate hinges 514-3, 514-4 may define the pivot axes to be substantially coplanar with the bottom surfaces of the frames 112a.

As referenced above, the patient table 500 may include a third leg system 122 (e.g., an intermediate leg system) that is rigidly coupled to the intermediate member 516 and extends downward therefrom. When in the collapsed configuration, the bottom surfaces of the frames 112a of the upper sections 512-2, 512-3 are parallel with and face toward each other (as shown in FIG. 5F). When in the collapsed configuration, the third leg system 122 (e.g., the intermediate leg system) may be positioned between the upper intermediate sections 512-2, 512-3, may be parallel with the bottom surfaces thereof, and may further be in contact therewith or bumpers therebetween. When in the expanded configuration, the bottom surfaces of the upper sections 512-2, 512-3 are parallel with and coplanar each other (as shown in FIGS. 5B and 5C). When in the expanded configuration, vertical end surfaces of the frames 112a of the intermediate upper sections 512-2, 512-3 may engage vertical surfaces of the intermediate member 516 to prevent further upward rotation and maintain the parallel and/or coplanar relationships between the upper sections 512-2, 512-3 (e.g., between the bottom and/or upper surfaces thereof).

The frames 112a of the intermediate sections 512-2, 512-3 may be shorter than the platforms 112b thereof in the direction of the extended length L_E, for example, being longer by approximately half the length of the intermediate member 516. As such, when in the expanded configuration, the platforms 112b may cover the intermediate member 516. Furthermore, the frames 112a of the intermediate sections 512-2, 512-3 may be shorter than the frames 112a of the end sections 512-1, 512-4 by approximately the same amount. For example, the frames 112a of the end sections 512-1, 512-4 may be approximately 17.5 inches long, the frames 112a of the intermediate upper sections 512-2, 512-3 may be approximately 16.75 inches long, and the intermediate member 516 may be approximately 1.5 inches, such that the frames 112a of the upper structure 110 are positioned adjacent each other to form the upper structure 110 with the extended length L_E of approximately 70 inches. The platforms 112b of the upper sections 512-1, 512-2, 512-3, 512-4 may all have a length of approximately 17.5 inches, such that the platforms 112b of the upper structure 110 are positioned adjacent each other to also form the upper structure 110 with the extended length of approximately 70 inches corresponding to that formed by the frames 112a.

The patient table 500 may include one or more securing mechanisms that, as described previously, selectively secure the upper sections 512 to each other in the expanded configuration to prevent rotation therebetween. For example, the side hinges 514-1, 514-2 may be configured as knife hinges that include a retractable pin 514a received in apertures of the to halves of the hinge to thereby prevent upward rotation of the upper sections 514-1, 514-2 and the upper sections 514-3, 514-4 relative to each other. The retractable pins 514a of each of the two hinges 514-1 or 514-2 on each end of the patient table 500 are configured to be actuated simultaneously to release the hinges 514-1 or 514-2. For example, as shown, each of the retractable pins 514a is sprung and configured to normally bias into the apertures of the hinge 514-1 associated therewith. Each of the pins 514a on the one side is operatively coupled to an actuator 514b, for example, with a cable 514c (e.g., similar to a brake cable having a cable that slides within an outer sheath). The actuator 514b may be configured, for example, as a button or a lever that pulls the cables 514c associated with each of the two pins 514a and, thereby, pulls the two pins 514a simultaneously from the two hinges 514-1 or 514-2 to permit the adjacent upper sections 512 to pivot relative to each other.

The patient table 500 may be configured without a securing mechanism between the intermediate upper sections 512-2, 512-3, or may further include a securing mechanism having a latch and striker (as described for the securing mechanism 118) that secures the intermediate upper sections 512-2, 512-3 to prevent downward rotation therebetween, or another securing mechanism (e.g., a slide pin).

In a preferred embodiment, the patient table 500 further includes the guard 340 as described previously with respect to FIGS. 3C and 3D. The patient table 500 still further includes the lifting system 450 as described with respect to FIGS. 4A-4B with either four of the legs 124 or six of the legs 124 (e.g., with six fluid circuits and twelve of the hydraulic actuator cylinders 454, as shown in FIG. 5A).

Referring to FIGS. 6A-6C, the patient table 100, 500 may include a variation of the lifting system 450. For example, a lifting mechanism 650 operates pneumatically. The lifting mechanism 650 includes gas lift cylinders 652 that change the patient table 100, 500 from a lowered to raised configuration and a winding system 654 that changes the patient table 100, 500 from the raised to the lowered configuration.

The gas lift cylinders 652 contain compressed gas, and when actuated (e.g., a locking switch is released) extend or contract if the force applied thereto is, respectively, less than or greater than the output force resulting from the compressed gas. Thus, in order to lift a patient, the gas lift cylinders 652 are configured to output force that is greater than that expected to be distributed thereto from the patient by the upper structure 110. In order to lower the patient table 100, 500, the winding system 654 is configured to apply force that is greater than that output by the compressed gas.

One set of the gas lift cylinders 652 is provided with each of the leg systems 122 (i.e., two of the legs 124 as shown) or may be provided in greater numbers, such as with one set of the gas cylinders 652 for each of the legs 124. Each set includes a number of gas lift cylinders 652 equal to the number of leg segments of the legs 124 that extend (e.g., telescope) from each other. As shown in FIGS. 6A-6C, the set includes two of the gas cylinders 652. An upper gas lift cylinder 652-1 is configured for the the middle leg sections 124-2 to extend from, lock, or retract into the upper leg sections 124-1. For example, the upper gas cylinder 652 may be coupled to and extend between the upper section 112 (or another cross member 126 extending between the upper leg sections 124-1) and the middle cross member 126-2 that is coupled to and extends between the lower ends of the middle leg sections 124-2. When not actuated, the upper gas lift cylinder 652-1 does not extend or retract and, thereby, prevents the middle leg sections 124-2 from moving relative to the upper leg sections 124-1. When actuated, the upper gas lift cylinder 652-1 permits the middle leg sections 124-2 to move relative to the upper leg sections 124-1, either extending or retracting depending whether the force applied thereto is less than or greater than that generated by the compressed gas. A lower gas lift cylinder 652-2 is configured and operates similar to the upper gas lift cylinder 652-1 but is instead coupled to and extends between the middle cross member 126-2 and the lower cross member 126-3, thereby preventing or allowing extension or retraction of the lower leg sections 124-3 relative to the middle leg sections 124-2. The gas lift cylinders 652 within a set (e.g., the upper and lower gas lift cylinders 652-1, 652-2) transfer force in series between the ground surface and the upper structure 110.

The gas lift cylinders 652 within a set (e.g., the upper and lower gas lift cylinders 652-1, 652-2) are operated simultaneously. Furthermore, the gas lift cylinders 652 of different sets (e.g., those at the first and second sides of the patient table 100) may also be operated simultaneously. More particularly, the gas lift cylinders 652 are operated simultaneously with a switch 652a that is operated manually by a user. The switch 652a is operatively connected to each of the gas cylinders 652 via cables 652b (e.g., brake-type cables having a wire that is pulled within and relative to a sheath) that, when pulled by the switch 652a (e.g., a lever), actuate the gas lift cylinders 652 simultaneously (e.g., releasing the switches thereof).

The winding system 654 is configured to compress the gas lift cylinders 652 and may be further configured to prevent the leg systems to prevent lifting of the upper structure 110. More particularly, the winding system 654 generally includes cables 654a, spools 654b, shafts 654c, and an input 654d. A set that includes one of the cables 654a, one of the spools 654b, and one of the shafts 654c is associated with each of the leg systems 122. Within a set, the cable 654a extends between one of the legs systems 122 and the spool 654b, the spool 654b is rotatably coupled to the frame 112a of the upper section 112, and the shaft 654c extends between the spool 654b and the input 654d to transfer torque therebetween. As shown, a first end of the cable 654a is coupled to the lower cross member 126-3, while a second end thereof is coupled to and winds around the spool 654b. The cable 654a may further extend through first and second pulleys (shown; not labeled) coupled to the frame 112a of the upper structure 112 and the middle cross member 126-2, or may instead extend directly between the lower cross member 126-3 and the spool 654b. The shafts 654c may be configured to bend or decouple and recouple as the upper sections 112 are pivoted relative to each other (i.e., when changing the patient table 100 between the collapsed and expanded configurations).

As a user rotates and applies torque to the input 654d (e.g., a crank handle), torque is transferred from the input 654d through the shaft 654c and ultimately to the spools 654b to apply torque thereto and cause rotation thereof to wind the cables 654a therearound. As the cables 654a are wound, the cables 654a apply force to and contract the leg systems 122 and the gas lift cylinders 652 to lower the patient table 100.

The winding system 654 may further include a brake 654e that prevents or slows movement of the cables 654a, for example, by selectively applying friction to the input 654d and/or locking the input 654d.

In order to raise the patient table 100, the user actuates the gas lift cylinders 652 with the switch 652a, which allows the gas lift cylinders 652 extend and, thereby, cause the leg systems 122 to extend substantially simultaneously and thereby raise the upper structure 110. To control the rate at which the upper structure 110 raises, the user may simultaneously activate the brake 654e of the winding system 654. In order to lower the patient table 100, the user actuates the gas lift cylinders 652 with the switch 652a and rotates the input 654d (e.g., rotating and applying torque manually), which in turns pulls the cables 654a around the spool 654b to retract the leg systems 122.

The lifting system 650 may also be configured to be used with the patient table 500 or other patient table having a third leg system 122, for example, by including an additional set of the gas lift cylinders 652 and additional set of the cable 654a, spool 654b, and shaft 654c.

Referring to FIGS. 7A-7F, a patient table 700 is a variation of the patient tables 100, 500, which includes an upper structure 710 that is a variation of the upper structure 110 and a lower structure 720 that is a variation of the lower structure 720. The upper structure 710 includes two upper sections 712 that are structured as generally described above for the upper sections 112 (e.g., including the frames 112a and the platforms 112b, which cooperatively define a cavities 112c), while also being configured to be arranged differently in the collapsed configuration and move differently between the expanded and collapsed configurations. The lower structure 720 includes leg systems 122 that may be generally configured as described above for the leg systems 122 at outer ends of the patient table 700 and may further include a central leg system 722. The central leg system 722 may, as shown, have a singular leg 124 arranged proximate a middle portion of the patient table 700 along the extended length L_E thereof and the width_W thereof, for example, being pivotably coupled to an inner end of one of the upper sections 712. The singular leg 124 is supported laterally by fixed length braces 724a that pivot with the singular leg 124 between stored and extended positions, while also having a collapsible brace 724b similar to the braces 128 that fold at an intermediate region thereof to permit the leg 124 to pivot into the cavity 122c of one of the upper sections 712. More particularly, the central leg system 722 is collapsible into the cavity 122c of a first of the two upper sections 712, while the pump 452 is contained in the cavity 122c of the second of the two upper sections 712.

When in the expanded configuration, bottom surfaces of the upper sections 712 are generally parallel with each other, coplanar with each other, or both (as shown). In the collapsed configuration, the bottom surfaces of the upper sections 712 on each side of the upper structure 710 are parallel with and face away from each other (e.g., being separated by the frames 112a thereof), while upper surfaces of the upper sections 712 the upper structure 710 are parallel with and face toward each other.

From the expanded to the collapsed configuration, the upper sections 712 are configured rotate upward relative to each other, for example, about a pivot hinge 714 that defines two pivot axes 714-1, 714-2. For example, a first of the two upper sections 712 may be supported by one of the leg systems 122 and the singular leg 124, while a second of the two upper sections 712 is pivoted about the pivot hinge 714 180 degrees (i.e., about the two pivot axes 714-1, 714-2 thereof), such that the upper surface of the second upper section 712 faces downward toward the upper surface of the first upper section 712 (see FIG. 7E). The two pivot axes 714-1, 714-2 are spaced apart to space the frames 112a of the upper sections 712 a sufficient distance for the platforms 112b and guards 744 to be received therebetween. The hinge 714 may be arranged in other manners to accommodate the platforms 112b and/or the guards 744 between the frames 112a, for example, by having a singular hinge point that is positioned outward of the upper sections 712 when in the in-use configuration.

The two frames 112a of the upper sections 712 may be approximately 35 inches long to cooperatively form an extend form the upper structure 710 with the extended length L_E of approximately 70 inches.

The patient table 700 may include one or more securing mechanisms that, as described previously, selectively secure the upper sections 712 to each other in the expanded configuration to prevent rotation therebetween. For example, the hinge 714 may include a retractable pins received in apertures of different sides of the hinge 714 to thereby prevent relative rotation of the upper sections 712. The retractable pins 714a hinges 714 may be configured to be actuated simultaneously to release the guards 744 and may be operated in the manner described previously for the hinges 514. The patient table 700 may instead be configured without a securing mechanism between the upper sections 714, may include a securing mechanism having a latch and striker (as described for the securing mechanism 118) that secures the intermediate upper sections 714 to prevent relative rotation therebetween, or another securing mechanism (e.g., a slide pin). The securing mechanism may may be configured as the securing mechanism 118 shown in FIG. 2D, for example, having latches 118a coupled to the frame 112a of the first of the upper sections 712 and strikers 118b coupled to that of the second of the upper sections 712.

Referring still to FIGS. 7A-7F, the patient table 700 includes guards 744 (e.g., rails or railings) that, when in use, are configured to extend upward from the side of the upper structure 710. For example, the patient table 700 may include four of the guards 744, each being coupled to one side (left or right) of one of the two upper sections 712. When the patient table 700 is collapsed, the one or more guards are configured to be stored between the two upper sections 712, or may alternatively be configured to store within a cavity defined by the frame 112a. The guards 744 may be configured to be non-expandable (as shown) or be expandable (as described previously for the guard 244 by having one portion that slides or otherwise moves relative to the other). The guards 744 may, for example, include a frame (e.g., a tubular frame) that defines the overall shape of the guards and may further include a cover (e.g., a pad) or other material extending across the frame. When in use, the guards 744 extend upward a height that may, for example, be between 6 and 12 inches above the upper surface of the upper section 712, and which may be constant or vary over the length thereof.

As illustrated in FIG. 7C, the guards 744 may be pivotably coupled to the upper sections 712, and in particular to the frames 112a thereof, so as to move between an in-use position (vertical and extending upward from the upper sections 712, as shown for the left guards 744) and storage position (horizontal and facing the upper surfaces of the upper sections 712, as shown for the left and right guards 744 in FIG. 7D). The guards 744 are pivotably coupled to the frames 112a with brackets 744a, which define a pivot axis proximate (or above) the upper sections 712, thereby allowing the guards 744 to fold downward to be positioned against the upper surface of the upper section 712. The brackets 744a may be further configured to retain the guards 744 in one or more of the in-use, stored, or access positions, for example, with friction fits and/or a mechanically locked position). For example, the hinge brackets 744a may include a lock mechanism that retains the guard 744 in the in-use position, which may be released with the same actuation mode as for securing the upper sections 712 to each other to prevent rotation therebetween. For example, a button may be operatively coupled via actuation cables to the hinges of the brackets 744a of the guards 744 and to the securing mechanism for the upper sections 712.

Furthermore, one or more of the guards 744 may be configured to fold downward to provide easier access for a patient to move to and from the patient table 700 (i.e., rotating 270 degrees between the storage and access positions). For example, the brackets 744a may further define a lower hinge point about which the bracket 744a and the guard 744 coupled thereto pivot downward relative to the frame 112a below the upper section 712. For example, all of the guards 744 (i.e., four of four total guards 744), both of the guards 744 on only one left or right side of the patient table 700 (e.g., two of four total guards 744), or one of the guards 744 on only one side of the patient table 700 (e.g., one of four total guards 744) may be configured to pivot downward to permit ingress and egress from the patient tale 700. The other of the guards 744 may be configured to rotate only between the in-use and storage positions (i.e., 90 degrees), which may be arranged toward a wall of a building in which the patient table 700 is used.

Referring still to FIGS. 7A-7F, the patient table includes wheels 729, which are configured to support the patient table 700 when in the collapsed configuration. The wheels 729 are coupled to and extend from the frames 112a of the two upper sections 712, for example, being coupled to inner ends of the two upper sections 712 (e.g., to the inner members of the frame 112a that extend laterally across the width_W of the upper sections 712). When the patient table 700 is in the collapsed configuration with the two upper sections 712 extending upward, the wheels 729 extend downward from the inner ends of the two upper sections 712 to engage a ground surface (e.g., a floor), so as to support the patient table 700 thereabove (e.g., with the two upper sections 712 extending substantially vertically). When the patient table 700 is in the in-use configuration with the two upper sections 712 extending parallel away from each other, those wheels 729 coupled to the first upper section 712 may be positioned below the second upper section 712, while those wheels 729 coupled to the second upper section 712 may be positioned below the first upper section 712.

To be used, the patient table 700 may begin in a fully-collapsed state (as shown in FIG. 7F). The legs 124 (e.g., of the leg systems 122, 722) are then moved from the stored position in the cavity 112c of the upper sections 712, and the patient table 700 moved from being supported by the wheels 129 to instead be supported by the legs 124 of that upper section 712 to which the central leg system 722 is coupled, with the other upper section 712 facing downward (see FIG. 7E). The other upper section is then rotated to face upward and such that the leg system 122 coupled thereto supports the upper section (see FIG. 7D). The guards 744 may then be pivoted from their stored positions (adjacent the upper sections 712) to extend upward for retaining a person (see FIG. 7C) and downward to permit ingress and egress of a person from the patient table 700. Once a patient is positioned on the patient table 700, all guards may be moved to extend upward and the pump 452 is operated, electrically or manually, to extend the legs 122 and raise the patient table from a lowered position to a raised position (compared FIG. 7D to FIGS. 7B and 7C). The patient table may be lowered 700 from the upper position to the lowered position by operating the pump 452, for example, allowing the weight of the patient table 700 and/or the patient thereon to cause the fluid to leave the hydraulic cylinders 454. The guards 744 may be lowered to allow egress of the patient. To then be collapsed, guards 744 are folded inward to face and be adjacent to the upper sections 712, and the other upper section 712 is folded about the hinge 714 (e.g., when released by the actuator) to rest on top of the first upper section. The patient table 700 is then moved to rest on the wheels 729, and the legs 122 collapsed to be stored in the respective cavities 112a of the upper sections 712 (i.e., by folding the braces 128, 724b). While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A patient table configured for lifting adult patients, the patient table comprising:
an upper structure configured support the adult patients thereon, the upper structure including upper sections that are pivotably coupled to each other to change the between expanded and collapsed configurations;
a lower structure configured to support the upper structure above a ground surface, the lower structure including leg systems that are each extendable to change between extended and unextended configurations and that are each pivotably coupled to one of the upper sections to change between an in-use configuration extending downward from the upper section to which it is coupled and a stowed configuration contained within the upper section to which it is coupled; and
a lifting system configured to change the leg systems from the unextended configuration to the extended configuration to lift the upper structure and from a lowered position to an elevated position, the lifting system being hydraulic.

2. The patient table according to claim 1, further comprising one or more guards, wherein each one of the guards is pivotably coupled to the upper section to move between positions extending upward from the upper section and being stored within a cavity of the upper section;
wherein the upper structure includes first, second, third, and fourth upper sections; and
wherein when changing from the expanded configuration to the collapsed configuration, the first upper section and the upper section pivot upward toward each other, the second upper section and the third upper section pivot downward toward each other, and the third upper section and the fourth upper section pivot upward toward each other.

3. The patient table according to claim 2, wherein the lifting system changes the leg systems from the unextended configuration to the extended configuration in unison.

4. The patient table according to claim 3, wherein the lifting system includes a hydraulic pump, hydraulic actuator cylinders, and hydraulic lines that cooperatively form hydraulic circuits, each of the hydraulic circuits associated with one leg of the leg systems.

5. The patient table according to claim 4, wherein each of the leg systems includes two of the legs, each of the legs includes three leg sections that are telescoping, and the lifting system includes two of the hydraulic actuator cylinders associated with each of the legs that cause the leg sections to telescopically extend from each other.

6. The patient table according to claim 5, wherein two leg systems include two outer leg systems that each include two of the legs and an inner leg system that includes only one of the legs, each of the legs includes three leg sections that are telescoping, and the lifting system includes two of the hydraulic actuator cylinders associated with each of the legs that cause the leg sections to telescopically extend from each other.

7. The patient table according to claim 6, wherein the upper sections include two of the upper sections that are pivotably coupled to each other and when extended form a length of the patient table.

8. The patient table according to claim 7, wherein one of the outer leg systems is pivotable between an extended position and a collapsed position in which the one leg system is stored in a first cavity of a first of the two upper sections, and wherein the other of the outer leg systems and the inner leg system are pivotable between extends and collapsed positions in which the other leg system and the inner leg system are stored in a second cavity of a second of the two upper sections.

9. The patient table according to claim 8, wherein the pump is positioned in the first cavity.

10. The patient table according to claim 4, wherein the hydraulic pump is configured to pump hydraulic fluid in the hydraulic circuits at the same rate.

11. The patient table according to claim 10, wherein the hydraulic pump is manually operated.

12. The patient table according to claim 1, wherein each the upper sections includes a frame that defines a lower surface of the upper section and a platform coupled to the frame that forms an upper surface of the upper section.

13. The patient table according to claim 12, wherein the upper sections consist of a first upper section and a second upper section that are pivotably coupled to each other with a hinge that defines two hinge axes about which the first upper section and the second upper section pivot relative to each other.

14. The patient table according to claim 13, further comprising one or more guards, each one of the guards coupled to one of the upper sections to both extend upward from the upper section and be stored between the upper surfaces of the upper sections when the patient table is in the collapsed configuration.

15. The patient table according to claim 14, wherein at least one of the guards is pivotably coupled to one of the upper sections and configured to additionally extend downward from the one upper section to allow ingress and egress of a patient.

16. A patient table configured for lifting adult patients, the patient table comprising:
an upper structure configured support the adult patients thereon, the upper structure including two upper sections that are pivotably coupled to each other to change the between expanded and collapsed configurations and in the expanded configuration form substantially an entire length of the patient table;
a lower structure configured to support the upper structure above a ground surface, the lower structure including leg systems that are each extendable to change between extended and unextended configurations and that are each pivotably coupled to one of the upper sections to change between an in-use configuration extending downward from the upper section to which it is coupled and a stowed configuration contained within the upper section to which it is coupled, wherein the leg systems include a first outer leg system coupled to a first of the upper structures, and a second out leg system and an inner leg system coupled to the second of the upper structures; and
a lifting system configured to change the leg systems from the unextended configuration to the extended configuration to lift the upper structure and from a lowered position to an elevated position, wherein the lifting system is hydraulic and includes a pump that is coupled to the first of the upper structures.

17. The patient table according to claim 16, further comprising guards, wherein in the collapsed configuration, upper surfaces of the two upper sections face each other with the guards positions therebetween, and in the expanded configurations, the guards extend upward from the upper sections to hinder egress of a patient from the patient table.

18. The patient table according to claim 16, further comprising wheels, each wheel coupled to an inner end of the upper section, wherein in the collapsed configuration, the wheels extend downward from the uppers sections to engage a floor surface and support the upper sections thereabove, and in the expanded configuration, each of the wheels extends under the one of the upper sections to which the wheel is not coupled.
